(19) United States
(12) Patent Application Publication
(10) Pub. No.: US 2023/0153161 A1
(43) Pub. Date: May 18, 2023

(54) OBSERVABILITY BASED WORKLOAD PLACEMENT

(71) Applicant: Cisco Technology, Inc., San Jose, CA (US)

(72) Inventors: Kyle Andrew Donald Mestery, Woodbury, MN (US); Ian James Wells, San Jose, CA (US)

(21) Appl. No.: 17/529,978

(22) Filed: Nov. 18, 2021

(51) Int. Cl. G06F 9/50; G06F 9/48

(52) U.S. Cl. CPC G06F 9/505; G06F 9/4818

(57) ABSTRACT

Techniques are described for using observability to allocate and deploy workloads for execution by computing resources in a cloud network. The workloads may be allocated and deployed to the computing resources based on metrics. The workloads may be deployed to the computing resources, based on the computing resources providing a number of types of observability that matches the number of metrics. The workloads may be deployed to the computing resources, further based on each of the computing resources matching a corresponding one of the metrics. Deployment of the workloads may be further based on availability of the computing resources. The workloads may be redeployed to other computing resources that provide different types of observability associated with the metrics, in comparison to the initial computing resources. The workloads may be allocated and deployed based on intent based descriptions indicating characteristics utilized to determine types of metrics for providing observability.

### TECHNICAL FIELD

The present disclosure relates generally to workload monitoring for workload resource allocation.

### BACKGROUND

Service providers offer monitoring services, or solutions, to provide users with observability resources associated with processing of workloads. These service providers often maintain networks of data centers which house devices, including servers, routers, and other devices, that provide computing resources to users. For instance, observability resources that are provided may include compute resources, networking resources, storage resources, database resources, application resources, security resources, and so forth. For instance, devices (e.g., user devices) utilizing the observability and computing resources may include computers (such as laptops, desktops, servers, smartphones, and tablets) and various other types of devices, which may include an ever-expanding array of Internet-of-Things (IoT) devices (such as cameras, door locks, doorbells, refrigerators, audio/visual systems, thermostats, and various sensors). Modern-day networks deliver various types of network architectures, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) Networks that operate WANs to provide connectivity to individual users or enterprises, and so forth.

The monitoring services may be utilized to track observability resource metrics (or “metrics”) associated with the computing resources. The metrics may include information about the computing resources utilized to process workloads. The computing resources may be associated with physical computing machines or virtual computing machines (or “virtual machines (VMs)”). The VMs may be scaled across physical servers in a cloud computing network. Each hardware piece of several pieces of hardware may perform a single function, or each VM of several VMs within a single piece of hardware may perform actions of one or more virtual network functions (VNFs). Containers may act as an operating system (OS) virtualization for network function virtualization. The containers may share the same host OS of a VM or run individual VNFs in an isolated manner such that each VM supports multiple containerized VNFs. The workloads may be routed to computing resources (e.g., network components (or “network devices”) in a serverless network by performing optimization of deployment locations including the computing resources.

In light of various limitations and disadvantages of monitoring computing resources that may be universally the same throughout the cloud network, instrumentation for observability of the computing resources has emerged. The instrumentation may include deploying program codes that are executed by the computing resources via processing of observability tools (e.g., Linux classic Berkeley packet filter (cBPF) programs, Linux extended BPF (eBPF) programs, etc.). The observability tools may be utilized to output information associated with utilization of the computing resources, such as whether a file is accessed by a user. The observability tools may be further utilized to identify information associated with data exchanged between various computing resources, such as devices that maintain databases, execute operating systems, and the like. The metrics may be retrieved by utilizing the observability tools to determine performance of the computing resources at runtime. However, various inefficiencies and disadvantages still exist when utilizing instrumentation for observability.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment that includes a network architecture that may include one or more data centers, and in which a user of a user device utilizes a workload orchestrator to execute a workload. FIG. 1 further illustrates a monitoring service to monitor execution of the workload based on metrics associated with selections indicated via user input.

FIG. 2 illustrates a system-architecture diagram of an environment that includes a network architecture that may include one or more data centers, and in which a user of a user device utilizes a monitoring service and a workload orchestrator to execute a workload. FIG. 2 further illustrates a workload orchestrator in a network architecture deploying the workload based on availability of computing resources.

FIG. 3 illustrates a system-architecture diagram of an environment that includes a network architecture that may include one or more data centers, and in which a user of a user device utilizes a monitoring service and a workload orchestrator to execute a workload. FIG. 3 further illustrates a workload orchestrator in a network architecture deploying the workload based on performance of execution of the workload.

FIG. 4 illustrates a system-architecture diagram of an environment that includes a network architecture that may include one or more data centers, and in which a user of a user device utilizes a monitoring service and a workload orchestrator to execute a workload. FIG. 3 further illustrates a workload orchestrator in a network architecture deploying the workload based on intent based descriptions.

FIG. 5 illustrates a computing system diagram illustrating a configuration for a workload orchestrator that may be utilized to implement aspects of the technologies disclosed herein.

FIG. 6 illustrates a flow diagram of an example method for deploying a workload.

### DESCRIPTION OF EXAMPLE EMBODIMENTS

### Overview

The present disclosure relates generally to utilizing workload resources to optimize processing of workloads by network devices.

A first method described herein includes utilizing requests indicating observability metrics received in requests received from user devices to manage allocation, deployment, and execution of workloads. The requests (or “user requests”) may be received for execution of workloads based on selections (or “user selections”) indicated via user input. Workload statuses (or “workload pending statuses”) may be determined as pending, based on the user requests. One or more metrics (or “user requested metric(s)”) associated with observability (or “user requested observability”) may be indicated by the user requests. The user requested metric(s) may be utilized to deploy the workloads to one or more computing resources. The workloads may be deployed to the computing resource(s) based on determining the computing resource(s) include one or more observability computing resources (or “observability resources”) associated with the user requested metric(s). The computing resource(s) may utilize the observability resource(s) to provide various types of observability, such as compute observability, storage observability, and network observability. The computing resource(s) may utilize the observability resource(s) to transmit the user requested metric(s) based on execution of the workloads.

A second method described herein includes utilizing availability of computing resources, to manage allocation, deployment, and execution of workloads. The workloads may be deployed based on availability of observability resources, which may be determined based on availability scores associated with the observability resources. One or more computing resources may be determined based on determining with a portion (e.g., a partial portion or an entire portion) of one or more observability resources in the computing resource(s) are associated with corresponding user requested metric(s). The computing resource(s) may be associated with one or more corresponding availability scores. The computing resource(s) (or “unavailable computing resource(s)”) may be determined to be not available based on the availability score(s) being less than one or more corresponding threshold availability scores. One or more other computing resources may be determined based on determining with another portion (e.g., a partial portion or an entire portion) of one or more other observability resources in the other computing resource(s) are associated with corresponding user requested metric(s). The portion of the other observability resource(s) may include the same or fewer observability resources than the portion of the observability resource(s) provided by the unavailable computing resource(s). The other computing resource(s) may be determined further based on determining one or more corresponding other availability scores associated with the other computing resource(s). The other computing resource(s) may be determined to be available based on the other availability score(s) meeting or exceeding one or more corresponding other threshold availability scores. The workloads may be deployed to the other computing resource(s), based on the other computing resource(s) being determined to be available.

A third method described herein includes utilizing workload migrate statuses (or “migrate statuses”) to manage allocation, deployment, and execution of workloads. The migrate statuses may be associated with workloads being executed by computing resources that include observability resources. One or more computing resources (or “initial computing resource(s)) currently executing the workloads may include a portion (e.g., a partial portion or an entire portion) of one or more observability resources associated with one or more metrics. The metric(s) (or “intuited metric(s)) may be determined based on performance of execution of the workloads by the initial computing resource(s). One or more other computing resources may include another portion (e.g., a partial portion or an entire portion) of the observability resources. The portion of the observability resource(s) included in the initial computing resource(s) executing the workloads may include different observability resources than the other portion of the observability resource(s). The migrate statuses associated with the workloads may be initially determined as pending. The migrate statuses associated with the workloads may be determined as active, based on determining the other computing resource(s) that include the other portion of the other observability resource(s) are available. The workloads may be migrated from the initial computing resource(s) to the other computing resource(s) based on the migrate statuses associated with the workloads being determined as active. The workloads may be migrated from the initial computing resource(s) to the other computing resource(s) by determining one or more potential destination locations, and a next placement associated with the workloads.

A fourth method described herein includes utilizing user intent to manage allocation, deployment, and execution of workloads. User requests for execution of workloads may be received based on selections (or “user selections”) indicated via user input. The user requests may include one or more intent based descriptions. Individual ones of the intent based descriptions may be associated with one or more user requested characteristics (or “characteristics”) associated with observability for the workloads. The user requested characteristic(s) may be utilized to determine one or more metrics associated with observability. One or more computing resources may be determined based on determining the computing resource(s) include one or more observability resources of the same type (e.g., category) as the metric(s). The computing resource(s) may be determined further based on determining the observability resource(s) are of the same sub-type (e.g., sub-category) as the metric(s). The workloads may be deployed to the computing resource(s) to execute the workloads and transmit the metric(s). One or more observability processes and/or one or more metrics streams may be determined based on the user requested characteristics(s), and utilized to transmit the metric(s).

Additionally, the techniques described herein may be performed by a system and/or device having non-transitory computer-readable media storing computer-executable instructions that, when executed by one or more processors, performs the method described above.

### Example Embodiments

Cloud computing has continued to evolve and become more complex in terms of how workloads are processed and managed by computing resources (or “computing resource components”) of cloud computing networks. For instance, observability technologies utilized to monitor effectiveness of computing resources that execute workloads continue to evolve. Observability technologies may be utilized to collect information associated with program execution (or “workload execution”), internal states of software being executed utilizing the computing resources, and communications exchanged between components of the computing resources. Observability technologies may utilize various techniques and tools, such as techniques and tools associated with logging, tracing, and the like.

As noted above, observability technologies traditionally were utilized to collect information associated with workload execution. However, due to limitations of observability technologies that universally provide the same type of observability for computing resources throughout a cloud network, instrumentation of the computing resources via various technologies, such as kernel technologies (e.g., extended Berkeley packet filter (eBPF) technologies) emerged. The kernel technologies are utilized to instrument kernel data structures (e.g., file descriptors, etc.) by executing program scripts via a system call. Instrumentation is utilized to optimize observability associated with the computing resources to provide various types of metrics based on execution of programs associated with instrumentation. However, various costs and limitations still exist when utilizing instrumentation to provide observability associated with execution of workloads. For example, utilizing kernel programs for observability may require additional amounts of time for, and/or result in decreased performance during, execution of the workloads by the computing resources.

This disclosure describes techniques and mechanisms for using observability to allocate and deploy workloads for execution by computing resources in a cloud network. In some examples, the workloads may be allocated and deployed to computing resources based on user requested metrics. In additional examples, workloads that are initially allocated to computing resources that are determined to have a lack of availability may be reallocated and deployed to other computing resources that provide observability that is different from the computing resources to which the workloads are initially allocated. Once workloads have been deployed to computing resources, the workloads may be redeployed to other computing resources that include more observability resources associated with the user requested metrics. In additional examples, workloads may be allocated and deployed based on intent based descriptions associated with user requested characteristics utilized to determine types of metrics for providing observability.

Generally, workloads are allocated to computing devices in cloud networks based on various types of considerations, such as business considerations (e.g., timeliness, legal/regulatory issues, asset control, global reach, etc.), technical considerations (e.g., performance, security, back-end integration, data volume, workload elasticity, etc.), ecosystem considerations (e.g., software as a service (SaaS) maturity, cloud service provider (CSP) offerings, market accessibility, etc.), and the like. This disclosure describes a workload orchestrator that allocates and deploys workloads to computing resources in cloud networks based on observability associated with workload execution.

As described herein, workloads generally are programmatic functions where pieces of code are executed by computing resources in networks, such as cloud networks. The functions may be compute functions, storage functions, and network functions. The computing resources to which the workloads are deployed may include physical computing machines (or “workstation elements”), virtual computing machines (or “virtual machines (VMs)”), containers, pods, or any other type of computing resources. The workloads may be deployed to other types of computing resources, such as network components (or “network devices”) in a serverless network by optimizing deployment locations that include the computing resources.

Thus, the workload orchestrator may receive requests (or “user requests”) associated with selections (or “user selections”) indicated by user input to user devices. The requests may indicate workloads and metrics utilized to provide observability associated with execution of the workloads. For instance, the metrics may include metrics associated with compute monitoring (or “compute metrics”), metrics associated with storage monitoring (or “storage metrics”), and/or metrics associated with network monitoring (or “network metrics”). The workload orchestrator may determine one or more computing resources including one or more observability resources associated with one or more metrics (or “user requested metric(s)”). The computing resource(s) may be determined for deployment of the workloads based on observability associated with the observability resource(s) being the same as observability associated with the user requested metric(s). The workload orchestrator may deploy the workloads to the computing resource(s) based on determining that individual ones of the observability resource(s) provide the same type of observability that is associated with one or more corresponding metrics among the user requested metric(s).

In some examples, the techniques described herein may include utilizing availability of computing resources to allocate and deploy workloads. The workloads may be initially allocated to one or more computing resource(s) that provide observability associated with one or more user requested metrics. The computing resource(s) may include one or more observability resources, with individual ones of the observability resource(s) providing the same type of observability that is associated with one or more corresponding metrics among the user requested metric(s). The workload orchestrator may determine one or more other computing resource(s) that include a portion (e.g., an entire portion or a partial portion) of the observability resource(s), based on determining the computing resource(s) are not available. The portion of the observability resource(s) in the other computing resource(s) may include fewer observability resources than in the initial computing resources(s). The workload orchestrator may allocate and deploy the workloads to the other computing resource(s), based on determining the other computing resource(s) are available.

As another example, the workload orchestrator may migrate workloads from one or more current computing resources to one or more other computing resources. The workload orchestrator may determine to migrate the workloads based on determining the current computing resource(s) include a portion (e.g., an entire portion or a partial portion) of one or more observability resource(s) associated with one or more metrics. The metric(s) (or “intuited metric(s)) may be determined based on performance of execution of the workloads by the current computing resource(s). The workload orchestrator may allocate the workloads to the other computing resource(s) based on determining the other computing resource(s) include more of the observability resource(s) associated with the user requested metric(s) than the current computing resource(s). The workload orchestrator may determine that another portion (e.g., an entire portion or a partial portion) of the observability resource(s) in the other computing resources(s) is larger than the portion of the observability resource(s) in the current computing resources(s). The workload orchestrator may migrate the workloads to the other computing resources(s).

As an even further example, the workload orchestrator may utilize intent based descriptions indicated in requests (or “user requests”) received from user devices to determine allocation and deployment of workloads. One or more characteristics associated with intent based descriptions received in one or more requests may be utilized to determine one or more metrics associated with observability. The workload orchestrator may determine the metric(s) and utilize the metric(s) to determine one or more computing resources. The computing resource(s) may be determined to allocate the workloads to the computing resource(s) based on determining the computing resource(s) include one or more observability resource(s) associated with the same type (e.g., category) of observability as the metric(s). The workload orchestrator may determine the computing resource(s) further based on the determining the observability resource(s) are associated with the same sub-type (e.g., sub-category) of observability as the metric(s). The workload orchestrator may deploy the workloads to the computing resource(s), which execute the workloads and transmit the metric(s).

While these are merely illustrative examples, other criteria or characteristics (discussed further below) may be considered when determining optimal, or optimized, computing resources on which to deploy and execute the workloads. The techniques are generally applicable to any type of cloud networks and network behavioral elements, including serverless networks. That is, the techniques for optimizing placement of workloads are generally applicable to any piece of software code that is a piece of networking behavior tailored to run in a convenient runtime environment (hardware or software) on a component in the network.

As described herein, a computing resource component may comprise any type of component, hardware-based, software-based, etc., that is capable of hosting or running a cloud network function or a serverless network function. For example, a computing resource component may comprise hardware-based devices such as a server, a router, a network switch (e.g., leaf switch, spine switch, etc.), a gateway, a network interface card (NIC), a smart NIC, a Field Programmable Gate Array (FPGA), an Application-Specific Integrated Circuit (ASIC), and/or any other hardware device capable of executing a serverless network function. The computing resource component may comprise a software-based component as well, such as a virtual machine, container, and so forth.

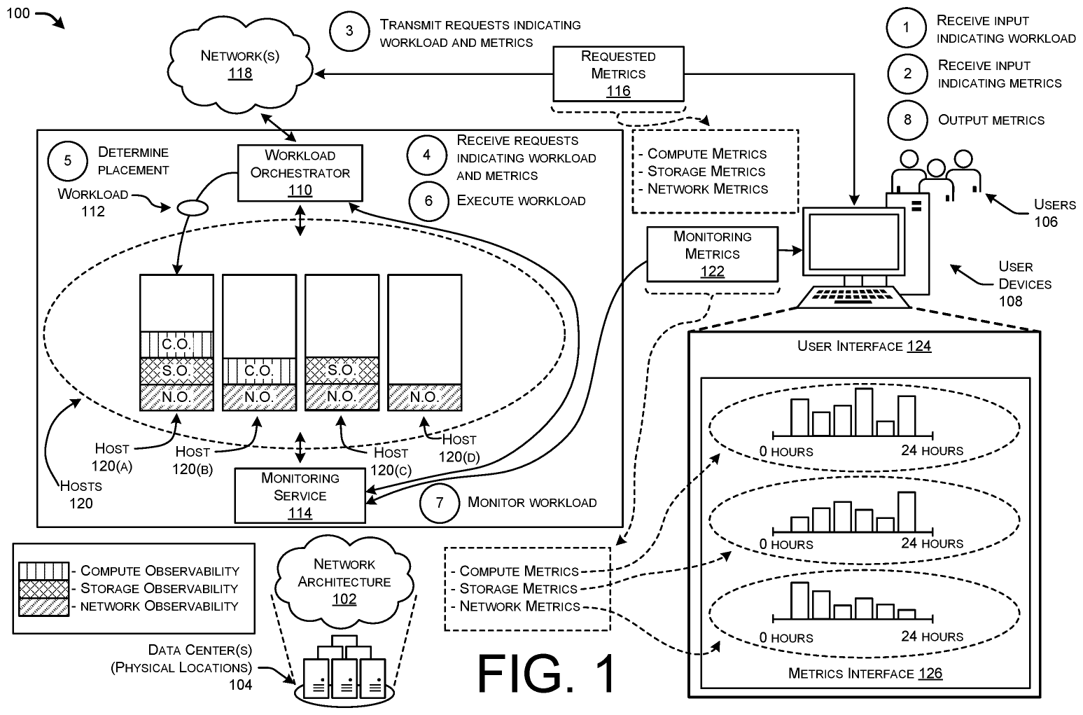

FIG. 1 illustrates a system-architecture diagram of an environment 100 that includes a network architecture 102 that may include one or more data centers 104, and in which a user 106 of a user device 108 utilizes a workload orchestrator 110 to execute a workload 112. FIG. 1 further illustrates a monitoring service 114 to monitor execution of the workload 112 based on one or more metrics (or “requested metric(s),” “user requested metric(s)”) 116 associated with selections indicated via user input.

In some examples, the network architecture 102 may include devices housed or located in one or more data centers 104. The network architecture 102 may include devices, virtual resources, or other nodes that relay packets from one network segment to another by nodes in the computer network. The network architecture 102 may include multiple devices that utilize the network layer (and/or session layer, transport layer, etc.) in the OSI model for packet forwarding, and/or other layers. The network architecture 102 may include various hardware devices, such as routers, switches, gateways, smart NICs, NICs, ASICs, FPGAs, servers, and/or any other type of device. Further, the network architecture 102 may include virtual resources, such as VMs, containers, and/or other virtual resources.

The one or more data centers 104 may be physical facilities or buildings located across geographic areas that designated to store networked devices that are part of the network architecture 102. The data centers 104 may include various networking devices, as well as redundant or backup components and infrastructure for power supply, data communications connections, environmental controls, and various security devices. In some examples, the data centers 104 may include one or more virtual data centers which are a pool or collection of cloud infrastructure resources specifically designed for enterprise needs, and/or for cloud-based service provider needs. Generally, the data centers 104 (physical and/or virtual) may provide basic resources such as processor (CPU), memory (RAM), storage (disk), and networking (bandwidth). However, in some examples the devices in the network architecture 102 may not be located in explicitly defined data centers 104, but may be located in other locations or buildings.

The user devices 108 may establish communication connections over one or more networks 118 to communicate with devices in the network architecture 102, such as the workload orchestrator 110 and the monitoring service 114 of the network architecture 102. The network(s) 118 may include any viable communication technology, such as wired and/or wireless modalities and/or technologies. Networks 118 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The user devices 108 may communicate using any type of protocol over the network 118, such as the transmission control protocol/Internet protocol (TCP/IP) that is used to govern connects to and over the Internet.

As illustrated, the user device 108 may receive one or more selections via input to the user device 108. As illustrated, the user device 108 may receive, at “1”, one or more selections via input (or “user input”) indicating the workload 112. The selection(s) may be received by the user device 108 to request execution of the workload 112, based on allocation and deployment of the workload 112 by the workload orchestrator 110.

At “2,” the user device 108 may receive one or more selections via user input indicating one or more metrics (or “requested metric(s),” “user requested metric(s)”) 116. Information (e.g., input data) associated with any of one or more of the selection(s) may be received by the user device 108 and transmitted to the workload orchestrator 110, which may utilize the requested metric(s) 116 for allocation and deployment of the workload 112. In some examples, the input data may be added to a user account (e.g., an account associated with the user 106), which may provide the user data that is transmitted to the workload orchestrator 110. Although the selection(s) indicating the workload 112 may be separate from the selection(s) indicating the metric(s) as discussed above in this disclosure, it is not limited as such. In some examples, any of the selection(s) indicating the workload 112 may be integrated (e.g., combined) together with any of the selection(s) indicating the metric(s), in any way.

The requested metric(s) 116 may include one or more compute metrics, one or more storage metrics, and/or one or more network metrics. For instance, the requested metric(s) 116 may include the compute requested metric(s) based on the user 106 determining the workload 112 is associated with compute functions. In some instances, the requested metric(s) 116 may include the storage requested metric(s) based on the user 106 determining the workload 112 is associated with storage functions. In those instances, or other instances, the requested metric(s) 116 may include the storage requested metric(s) based on the user 106 determining the workload 112 is associated with storage functions. In those instances, or other instances, the requested metric(s) 116 may include the network requested metric(s) based on the user 106 determining the workload 112 is associated with network functions.

By providing the selection(s) via the user input indicating the requested metric(s) 116, the user 106 may prioritize the requested metric(s) 116 with respect to one or more remaining metrics not indicated by the selection(s). The user 106 may determine to, based on the remaining requested metric(s) being relatively less important for purposes of managing execution of the workload 112, refrain from providing input indicating the remaining requested metric(s). In some examples, and as a result of the requested metric(s) 116 being prioritized by the selection(s), information associated with the requested metric(s) 116 provided to the workload orchestrator 110. In those examples, the information associated with the requested metric(s) 116 may be added to the user account. The information associated with the requested metric(s) 116 may be provided from the user account and to the workload orchestrator 110. The workload orchestrator 110 may utilize the information associated with the requested metric(s) 116 for allocation and deployment of the workload 112.

At “3,” the user device 108 may transmit a request (or “user request”) indicating the workload 112 and the requested metric(s) 116 to the workload orchestrator 110, via the network(s) 118. The user request may include user data from a user account (e.g., an account associated with the user), the user data including any information (or “workload information”) associated with the workload 112. The workload information may include any information utilized for execution of the workload 112, such as a workload priority, a workload identifier, a workload type, a workload version, resource consumption requirements, etc. The workload information may include data of the workload 112 to be utilized at execution of the workload 112). Additionally or alternatively to the user request, any of the workload information may be determined based on historical data associated with workload resource consumption (e.g. consumption of one or more workload resources).

In some instances, the user request may include, in the user data, information associated with the requested metric(s) 116. For instance, the user request may be utilized to determine whether to provide observability associated with individual ones of the requested metric(s) 116 based on corresponding metric information in the user request. The corresponding metric information may include a metric priority value (or “requested metric priority value”) indicating a metric priority, a metric identifier associated with the metric, a metric type value indicating a metric type, a program identifier (e.g., an identifier of a program and/or function that may be implemented/executed for determining the corresponding metric), resource consumption requirements, and any other information to be utilized for providing observability. Additionally or alternatively to the user request, any of the metric information may be determined based on historical data associated with workload resource consumption (e.g. consumption of one or more workload resources).

At “4,” the workload orchestrator 110 may receive the user request indicating the workload 112 and the requested metric(s) 116. The workload orchestrator 110 may receive, in the user request, the workload information and the metric information.

At “5”, the workload orchestrator 110 may determine a placement associated with the workload 112. To determine the placement, the workload orchestrator 110 may determine one or more potential destination locations. The workload orchestrator 110 may determine the requested metric(s) 116 based on the metric information included in the user request. In some instances, the determining of the placement may include determining one or more of computing resources (or “host(s)”) 120a-120d (collectively referred to herein as hosts 120), as the potential destination location(s). For instance, with examples in which the requested metric(s) 116 indicated via the user request include multiple requested metrics (e.g., a metric (or “compute metric”) associated with compute observability, a metric (or “storage metric”) associated with storage observability, and a metric (or “network metric”) associated with network observability) 116, the workload orchestrator 110 may determine the placement of the workload 112 as the host 120(a). The workload orchestrator 110 may determine to place the workload 112 on the host 120(a), as a destination location.

The determining of the placement of the workload 112 may include determining to allocate the workload 112 to the host 120(a), based on the host 120(a) including observability (e.g., compute observability, storage observability, and network observability) associated with each of the requested metrics 116 (e.g., the compute metric, the storage metric, and the network metric) that are indicated via the request received from the user device 108. The placement of the workload 112 on the host 120(a) may be determined based on the host 120(a) providing observability via one or more observability resources in the host 120(a). The observability resource(s) in the host 120(a) may include multiple observability resources, including one or more compute observability resources utilized to provide compute observability, one or more storage observability resources utilized to provide storage observability, and one or more network observability resources utilized to provide network observability.

At “6,” the host 120(a) may execute the workload 112. In some instances, the workload orchestrator 110 may cause the host 120(a) to execute the workload 112, such as by transmitting, to the host 120(a), the workload 112, along with and a request (or “orchestrator request”) to execute the workload 112. For instance, the host 120(a) may execute the workload 112 based on receiving the workload 112, such as by automatically executing the workload 112 upon receipt. In other instances, the host 120(a) may execute the workload 112 based on information (or “workload orchestrator information”) received from the workload orchestrator 110. The workload orchestrator information may indicate the workload 112, a priority (or “workload priority”) associated with the workload 112, the metrics 116, and/or individual priorities associated with the corresponding metrics 116. In any of the instances as discussed above, the host 120(a) may execute the workload 112 by adding a workload entry to a queue in the host 120(a), and executing the workload 112 based on the workload entry being at a top of the queue.

At “7,” the monitoring service 114 may monitor execution of the workload 112 to provide observability. Different types of observability (or “observability types”) may be provided, including compute observability, storage observability, and network observability. The monitoring of the execution of the workload 112 may include monitoring different types of performance (or “performance types”) associated with execution of the workload 112. Individual types of observability that are provided may be associated with corresponding performance types. Compute observability associated with compute performance, storage observability associated with storage performance, and network observability associated with network performance may be provided by the monitoring service 114. The monitoring metric(s) 122 may include multiple monitoring metrics 122, based on the requested metrics 116 being utilized to determine execution, by the host 120(a), of the workload 112.

In some instances, the different types of observability that are provided may include compute observability that is provided by determining one or more compute metrics of the monitoring metrics 122, storage observability that is provided by determining one or more storage metrics of the monitoring metrics 122 and network observability that is provided by determining one or more network metrics of the monitoring metrics 122. The different types of observability may be provided by transmitting, by the monitoring service 114 and to the user device 108, the monitoring metrics 122. The monitoring metrics 122 that are transmitted may include the compute metric(s), the storage metric(s), and the network metric(s).

At “8,” a user interface 124 of the user device 108 may be utilized to output the monitoring metrics 122. The user device may receive the monitoring metrics 122, including the compute metrics, the storage metrics, and the network metrics. The compute metrics, the storage metrics, and the network metrics may be displayed by a metrics interface 126 of the user interface 124.

The monitoring metrics 122 that are displayed may include monitoring metrics 122 that are monitored over a period of time (e.g., a period of time between a time at which the workload 112 begins to be executed until a time 24 hours later). Although a period of time that is 24 hours long is illustrated in FIG. 1, as discussed above in the current disclosure, it is not limited as such. Individual periods of time may be for any length of time. Alternatively or additionally, one or more periods of time (e.g., periods (or “intervals”) of time that are consecutive, or periods of time with one or more periods of time being spaced apart by other periods (or “intervening periods?) during which metrics are not monitored) of any length of time, may be utilized to display the monitoring metrics 122.

In this way, workloads may be routed to hosts in order to perform functions that are traditionally performed utilizing the hosts to execute the workloads. However, the techniques described herein include using metrics indicated by requests from user devices to determined placement of workloads indicated by the requests. By determining the placement of workloads based on metrics (e.g., requested metrics), workloads may be allocated to some hosts due to not all of the hosts including the same observability. Because providing observability may effect various aspects of the hosts, such as system performance and power consumption, and may require more complex and/or expensive hardware, utilizing the observability provided by the hosts to determine workload placement enables some, but not all, hosts to provide certain types of observability. The workloads are placed on the hosts that provide the required types of observability, while other hosts that are not utilized to execute the workloads may be utilized to provide different types of observability utilized by other workloads. Overall system efficiency and performance may be improved.

Although the workload orchestrator 110 may determine to place the workload 112 on the host 120(a) based on individual types of observability (or “matching host observability types”) provided by the host 120(a) that match corresponding types of observability (or “metrics observability types) associated with the metrics 116 as discussed above in the current disclosure, it is not limited as such. Individual host configurations may be associated with corresponding numbers of types of observability (e.g., a host may be associated with a number of the host observability types). In some examples, the workload orchestrator 110 may determine to place the workload 112 on the host 120(a) based on a number (e.g., three) of matching host observability types (e.g., host observability types that each match an observability types associated with one of the metrics 116) associated with the host 120(a) meeting or exceeding a number of matching host observability types associated with any of the remaining hosts 120 (e.g., the host 120(b) provides two host observability types, including compute observability and network observability, each of which matches one of the metrics observability types). In other examples, the workload orchestrator 110 may determine to place any workload on any host, based on the host corresponding configuration, in a similar way as for the workload 112 being place on the host 120(a).

Alternatively or in addition to utilizing the number of the matching host observability types, the workload orchestrator 110 may determine workload placement based on one or more observability priorities. Individual ones of the observability priority(ies) may be associated with corresponding metric priority values (e.g., the request metric priority values received in the user request). The workload orchestrator 110 may determine whether to utilize the metric priority value(s) to place the workload 112 on the host 120(a). In a case in which the number of the matching host observability types associated with the host 120(a) meets or exceeds the number of matching host observability types associated with any of the remaining hosts 120, the workload orchestrator 110 may determine to refrain from utilizing the metric priority values to place the workload 112. In some examples, the workload orchestrator 110 may utilize predetermined metric priority values based on the user request not including at least one metric priority value (e.g., a number of metric priority values in the user request being less than a number of the metrics 116). Individual predetermined metric priority values associated with the corresponding observability priorities may be utilized to place the workload 112, based on the corresponding metric priorities being absent from the user request. Any of the techniques utilizing the received metric priority values, as discussed herein, may be implemented in a similar way, by utilizing individual ones of the predetermined metric priority values associated with the corresponding metrics for which priority values were not received.

The workload orchestrator 110 may utilize deployment weights associated with numbers of observability types and observability priorities, to determine workload placement. The deployment weights may include one or more deployment weights (or “initial deployment weight(s)”) based on one or more weight values. In some examples, the weight value(s) may include multiple weight values, including a weight value associated with determining the workload placement based on numbers of observability in corresponding hosts 120. In those examples, the multiple weight values may include a weight value associated with determining the workload placement based on observability priorities. In some instances, the workload orchestrator 110 may determine to utilize the numbers of observability in corresponding hosts 120, but not the observability priorities, to determine the workload placement, based on the weight value associated with the numbers of observability in corresponding hosts 120 being larger than the weight value associated with observability priorities. In other instances, the workload orchestrator 110 may determine to utilize the observability priorities, but not the numbers of observability in corresponding hosts 120, to determine the workload placement, based on the weight value associated with the numbers of observability in corresponding hosts 120 being less than the weight value associated with observability priorities. In other instances, the workload orchestrator 110 may determine to utilize the numbers of observability in corresponding hosts 120, as well as the observability priorities, to determine the workload placement, based on the weight value associated with the numbers of observability in corresponding hosts 120 being the same as the weight value associated with observability priorities.

Weight values (or “requested weight value(s)”) may be received in the user request. The deployment weights may include one or more deployment weights (or “modified deployment weight(s)”) based on the requested weight value(s) and/or one or more predetermined weight values. In some examples, the requested weight value(s) may be replaced by the predetermined weight value(s) to replace the initial deployment weight(s) with the modified deployment weight(s). In other examples, the requested weight value(s) may be integrated with the predetermined weight value(s) to determine combined deployment weight(s). Individual ones of the initial requested weight value(s) may be combined with corresponding predetermined weight value(s) to determine the combined deployment weight(s) as the modified deployment weight(s). By way of example, individual ones of the combined deployment weight(s) may be an average of the corresponding initial requested weight value(s) and the corresponding predetermined weight value(s). Any of the weight values associated with the initial deployment weight(s), or the weight values associated with the modified deployment weight(s), may be implement as the weight values utilized for determining the workload placement, as discussed above.

Although the workload orchestrator 110 is separate from the monitoring service 114 as discussed above in the current disclosure, it is not limited as such. The workload orchestrator 110 may be integrated, and/or combined, with the monitoring service 114, and utilized in any of the techniques as discussed herein to implement one or more of the functions of the workload orchestrator 110 and/or the functions of the monitoring service 114.

Although workloads may be compute functions, storage functions, and network functions as discussed above in the current disclosure, it is not limited as such. Any of the techniques related to workloads as discussed herein may be implemented in a similar way for workloads including one or more types of functions, including compute functions, storage functions, network functions, and any other type of functions. Although observability includes compute observability, storage observability, and network observability as discussed above in the current disclosure, it is not limited as such. Any of the techniques related to observability as discussed herein may be implemented in a similar way for one or more types of observability, including compute observability, storage observability, network observability, and any other type of observability. Although metrics include compute metrics, storage metrics, and network metrics as discussed above in the current disclosure, it is not limited as such. Any of the techniques related to metrics as discussed herein may be implemented in a similar way for one or more types of metrics, including compute metrics, storage metrics, network metrics, and any other type of metrics.

Although the different types of observability may be associated with corresponding types of metrics that are monitored and transmitted as discussed above in this disclosure, it is not limited as such. The term “metrics,” referring to data that is utilized for managing workload execution, and the term “observability,” referring to the concept of utilizing data for managing workload execution, may be interpreted as being interchangeable for purposes of any of the techniques discussed throughout this disclosure.

Although the term “computing resource(s)” may include resources of a host that are utilized to execute workloads, and the term “observability resource(s)” may include resources of a host that are utilized to provide observability, as discussed in this disclosure, it is not limited as such. The term “computing resource(s)” may be interpreted throughout the disclosure herein to refer to one or more hosts, one or more computing resources in a host, one or more observability resources in a host, any combination of one or more resources (e.g., the computing resource(s) and/or the observability resource(s)) in a host or multiples hosts. The computing resource(s) according to any interpretation as discussed above may be utilized to implement the computing resources(s) and/or the observability resource(s) utilized in any of the techniques as discussed throughout this disclosure.

Although computing resource(s) not utilized to provide observability may be implemented separately from computing resource(s) (e.g., observability resource(s)) utilized to provide observability as discussed above in this disclosure, it is not limited as such. In some examples, the computing resource(s) not utilized to provide observability and the computing resource(s) (e.g., observability resource(s)) utilized to provide observability may be integrated and utilized to perform any techniques associated with any computing resource(s) functions and/or any observability resource(s) functions as discussed throughout this disclosure.

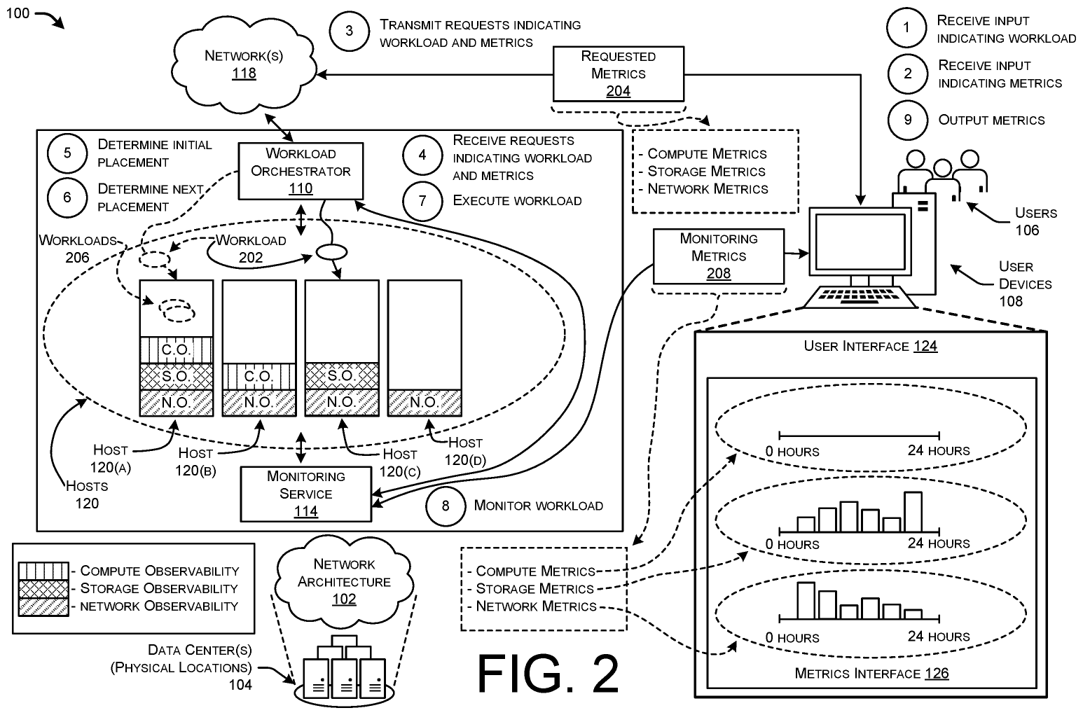

Although individual portions of the user interface 124 may be utilized to display the corresponding metrics as discussed above in this disclosure, it is not limited as such. In some examples, any portion of the user interface 124 utilized associated with observability that is not being monitored for the workload 202 may be omitted. The user interface 124, instead of having three portions, may include any number (e.g., 2, 4, 6, 8, 10, 20, 40, etc.) of portions, with individual ones of the portions (e.g., an upper portion and a lower portion) being utilized to display the corresponding metrics associated with the corresponding observability (e.g., the storage observability and the network observability, respectively) provided by the host 120(c). Although individual portions of the user interface 124 may be utilized to display the corresponding metrics as a bar graph as discussed above in this disclosure, it is not limited as such. In some examples, individual portions of the user interface 124 may be utilized to display the corresponding metrics in any form (e.g., a line graph, a pie graph, numerical characters, FIG. 2 illustrates a system-architecture diagram of an environment that includes a network architecture that may include one or more data centers, and in which a user of a user device utilizes a monitoring service and a workload orchestrator to execute a workload. FIG. 2 further illustrates a workload orchestrator in a network architecture deploying the workload based on availability of computing resources.

As illustrated, at “1”-“3,” the user device 108 may perform similar functions utilizing a workload 202 and requested metric(s) 204, in a similar way as for the workload 112 and the requested metric(s) 116 at “1”-“3,” as discussed above with reference to FIG. 1. At “4,” the workload orchestrator 110 may receive the request indicating the workload 202 and the requested metric(s) 204, in a similar way as for the workload 112 and the requested metric(s) 116 at “4,” as discussed above with reference to FIG. 1.

At “5”, the workload orchestrator 110 may determine a placement (or “initial placement”) associated with the workload 202. To determine the initial placement, the workload orchestrator 110 may determine one or more potential destination locations. The determining of the placement may include determining one or more of computing resources (or “host(s)”) 120a-120d (collectively referred to herein as hosts 120), as the potential destination location(s).

In some instances, with examples in which the requested metric(s) 116 include multiple requested metrics (e.g., a metric (or “compute metric”) associated with compute observability, a metric (or “storage metric”) associated with storage observability, and a metric (or “network metric”) associated with network observability) 116, the workload orchestrator 110 may determine the initial placement of the workload 112 as the host 120(a). The determining of the initial placement of the workload 112 may include determining to allocate the workload 112 to the host 120(a), based on the host 120(a) including observability (e.g., compute observability, storage observability, and network observability) associated with each of the requested metrics 116 (e.g., the compute metric, the storage metric, and the network metric) that are indicated via the request received from the user device 108

At “6,” the workload orchestrator 110 may determine a placement (or “next placement”) based on availability associated with the host 120(a). In some instances, the host 120(a) may be executing one or more other workloads 206. For instance, as illustrated, the workload(s) 206 being executed by the host 120(a) may include multiple workloads 206. The workload orchestrator 110 may determine the availability of the host 120(a) based on determining the host 120(a) is executing the workloads 206.

The availability of the host 120(a) may be determined by the workload orchestrator 110 and/or the host 120(a). In some cases, in which the availability of the host 120(a) is determined by the host 120(a), the workload orchestrator 110 may transmit a request (or “availability request”) to the host 120(a). The workload orchestrator 110 may receive information (or “availability information”) associated with the availability of the host 120(a) in a response (or “availability response”) received from the host 120(a).

The host 120(a) may determine the availability information based on workload information, metric information, and/or availability of various types of resources of the host 120(a). In some instances, the availability request transmitted to the host 120(a) may include workload information associated with the workload 202 and/or metric information associated with the metrics 204. The host 120(a) may determine availability of computing resources of the host 120(a) that are utilized to execute workloads (e.g., the workloads 206), and/or availability of observability resources of the host 120(a) that are utilized to provide observability. In some examples, the host 120(a) may determine the availability of computing resources of the host 120(a) at any time, such as an ongoing basis. In other examples, the host 120(a) may determine the availability of computing resources of the host 120(a), based on receiving the availability request.

Availability of the computing resources of the host 120(a) may be determined based on resources of the host 120(a) that are associated with execution of the workloads 206 and/or observability. A portion (e.g., first portion) (e.g. a partial portion of an entire portion) of computing resources of an entire portion of computing resources of the host 120(a) that are available may be determined by the host 120(a). A portion (e.g., second portion) (e.g. a partial portion of an entire portion) of observability resources of the entire portion of computing resources of the host 120(a) that are available, may be determined by the host 120(a).

The host 120(a) may transmit the availability information utilized by the workload orchestrator 110 to determine availability of the host 120(a). The availability information received from the host 120(a) may indicate any of one or more results of determinations (or “availability determinations) of availability of the host 120(a). In some examples, the availability information may indicate a result (or “computing resources availability result”) (e.g., first result) of a determination (or “computing resources availability determination”) (e.g., first availability determination) of whether an amount of available computing resources (or “available computing resources amount) (e.g., an amount (e.g., first amount) of the portion of available computing resources meets or exceeds a required resources amount (e.g., an amount of computing resources associated with execution of the workload 202, and/or a combination of an amount of computing resources associated with execution of the workload 202 and an amount of observability resources required to provide the metrics 204). The computing resources availability result may be determined as a value (e.g., first value) based on the result indicating the available computing resources amount meets or exceeds the required computing resources amount, or another value (e.g., second value) based on the result indicating the available computing resources amount is less than the required computing resources amount.

Alternatively or additionally, the availability information may indicate a result (e.g., second result) (or “observability resources availability result”) of a determination (or “observability resources availability determination”) (e.g., second availability determination) of whether an amount (or “available observability resources amount) (e.g., second amount) of the portion of available observability resources meets or exceeds the required resources amount (e.g., the amount of computing resources associated with execution of the workload 202, and/or the combination of the amount of computing resources associated with execution of the workload 202 and the amount of the observability resources required to provide the metrics 204).

The availability information may indicate positive availability based on positive results of the availability determinations. The availability information may include an availability value (or “positive availability value”) (e.g., first availability value), based on the observability resources availability result indicating that the available observability resources amount meets or exceeds the required resources amount. In some examples, the positive availability value may be included in the availability information, based on a combination of i) the observability resources availability result indicating that the available observability resources amount meets or exceeds the required resources amount, and ii) the computing resources availability result indicating that the available computing resources amount meets or exceeds the required resources amount. The workload orchestrator 110 may determine the availability of the host 120(a) as positive, based on the positive availability value.

The availability information may indicate negative availability based on negative results of the availability determinations. The availability information may include an availability value (or “negative availability value”) (e.g., second availability value), based on the observability resources availability result indicating that the available observability resources amount is less than the required resources amount. In some examples, in cases in which the available computing resources amount meets or exceeds the required resources amount, the negative availability value may be included in the availability information, based on the observability resources availability result indicating that the available observability resources amount is less than the required resources amount. In other examples, the negative availability value may be included in the availability information, based on a combination of i) the observability resources availability result indicating that the available observability resources amount is less than the required resources amount, and ii) the computing resources availability result indicating that the available computing resources amount is less than the required resources amount. The workload orchestrator 110 may determine the availability of the host 120(a) as negative, based on the negative availability value.

Alternatively or additionally to receiving the availability information in the availability response from the host 120(a), the workload orchestrator 110 may determine the availability of any of the hosts 120 (e.g., the host 120(a)) by determining the corresponding availability information for the host 120. The workload orchestrator 110 may determine the availability information based on information (or “received availability information”) in the availability response received from the host 120(a). The workload orchestrator 110 may transmit, in the availability request, an identifier (or “available computing resources amount identifier”) (e.g., first identifier) to request the available computing resources amount. The host 120(a) may transmit, in the availability response, the available computing resources amount based on determining the availability request includes the available computing resources amount identifier. In some examples, the host 120(a) may transmit, in the availability response, an amount of an entire portion of computing resources and/or an amount of a portion of the available computing resources of the host 120(a). The workload orchestrator 110 may perform the computing resources availability determination based on the received availability information (e.g., any of the received information, such as the available computing resources amount).

The workload orchestrator 110 may determine the availability information indicating the observability availability. The workload orchestrator 110 may transmit, in the availability request, an identifier (or “available observability resources amount identifier”) (e.g., second identifier) to request the available observability resources amount of any of the hosts (e.g., the host 120(a)). The host 120(a) may transmit, in the availability response, the available observability resources amount based on determining the availability request includes the available observability resources amount identifier. The received availability information may include an amount of an entire portion of observability resources and/or an amount of a portion of the available observability resources of the host 120(a). The workload orchestrator 110 may perform the observability resources availability determination based on the received availability information (e.g., any of the received information, such as the available observability resources amount). The workload orchestrator 110 may determine the availability information based on the computing resources availability determination and/or the observability resources availability determination in a similar way as discussed above for the host 120(a).

In some examples, the workload orchestrator 110 may determine the availability of the host 120(a) continuously, in real time. In some examples, the host 120(a) may transmit the availability information to the workload orchestrator 110 at predetermined time intervals (e.g., time intervals determined based on time interval indicators transmitted by the workload orchestrator 110 to the host 120(a)) (e.g., intervals of one millisecond, one second, one minute, one hours, one day, or any amount of time).

In some examples, the workload orchestrator 110 may determine the availability of the host 120(a) continuously or dynamically. In cases in which the availability information is transmitted by the host 120(a) continuously, or in other cases in which the availability information is not continuously transmitted, the host 120(a) may transmit information to the workload orchestrator 110 based on determining one or more of the first portion of the computing resources and the second portion of the observability resources of the host 120(a) are modified. The workload orchestrator 110 may determine (or “dynamically determine”) the availability of the host 120(a) based on the host 120(a) transmitting, in real-time, the availability information based on the first portion and/or the second portion being modified. By way of example, the availability information may be transmitted at a time at which modification of the first portion and/or the second portion occurs (e.g., the availability information may be transmitted within a threshold amount of time after the modification of the first portion and/or the second portion occurs). In some examples, the modification may include a modification of an amount of resources meeting or exceeding a threshold amount of resources (e.g. a percentage of resources being utilized exceeding a percentage (e.g., 10%, 20%, etc.) of resources of that type (e.g., computing or observability), and/or exceeding a percentage (e.g., 10%, 20%, etc.) of total resources of the host). The first portion of the computing resources being modified may include execution of any of one or more of the workloads (e.g., the workloads 206 and/or the workload 202) beginning, changing, and/or ending. The second portion of the observability resources being modified may include observability being added, or removed, from the host 120(a), and/or changes in observability associated with execution of one or more other workloads beginning, changing, and/or ending.

The workload orchestrator 110 may receive, from one or more other hosts (e.g., the hosts 120(b)-(d)), availability information, and/or determine availability information associated with one or more other hosts (e.g., the hosts 120(b)-(d)). The availability information associated with the hosts 120(b)-(d) may be received, and/or determined, by the workload orchestrator 110 in a similar way as for the host 120(a). In some examples, the workload orchestrator 110 may determine availability of individual ones of the hosts 120(a)-120(d) together (e.g., the determining of the availability of the host 120(a) may include determining the availability of the hosts 120(b)-120(d)). In other examples, the workload orchestrator 110 may determine the availability of the host 120(a), prior to determining the availability of any of the hosts 120(b)-120(d). In those examples, the workload orchestrator 110 may determine the availability of the host 120(a), and, based on the availability of the host 120(a) being determined to be negative, determine the availability of one or more of the remaining hosts 120 (e.g., the hosts 120(b)-120(d)).

The workload orchestrator 110 may determine, based on the availability associated with host 120(a) being negative, one or more other potential destination locations. The other potential destination locations may be determined based on the workload orchestrator 110 determining that no host among the hosts 120 is available for providing observability for all of the metrics 204. The other potential destination location(s) may include one or more remaining hosts 120 (e.g., the hosts 120(b)-120(d)). The workload orchestrator 110 may determine individual ones of the hosts 120(b)-120(d) as corresponding potential destination locations. Individual ones of the hosts 120(b)-120(d) may be determined as corresponding potential destination locations based on the corresponding availability information (e.g., the corresponding availability information associated with the corresponding hosts 120(b)-120(d) that is determined, and/or received, by the workload orchestrator 110).

The workload orchestrator 110 may modify, or refine, the other potential destination location(s) as including a portion of the remaining host(s) 120 (e.g., the hosts 120(b) and 120(c)), based on corresponding numbers of matching host observability types. In some examples, the workload orchestrator 110 may modify, or refine, the other potential destination location(s) as including the hosts 120(b) and 120(c), based on a number (e.g., two) of the matching host observability types associated with each of the hosts 120(b) and 120(c) meeting or exceeding a number of matching host observability types associated with the remaining host 120 (e.g., the host 120(c) provides one matching host observability types, including network observability).

Alternatively or additionally to utilizing corresponding numbers of matching host observability types to modify the other potential destination location(s) as including the portion of the remaining host(s) 120 (e.g., the hosts 120(b) and 120(c)), the workload orchestrator 110 may utilize metric priorities. The workload orchestrator 110 may determine an observability priority (e.g., an observability priority of the compute observability for the workload 202) associated with a metric priority value of the compute metric, an observability priority (e.g., an observability priority of the storage observability for the workload 202) associated with a metric priority value of the storage metric, and an observability priority (e.g., an observability priority of the network observability for the workload 202) associated with a metric priority value of the network metric. The next placement of the workload 202 may be determined based on the observability priorities associated with the corresponding metric priority values. The workload orchestrator 110 may modify the other potential destination location(s) as including the hosts 120(b) and 120(c) based on determining an observability priority of the network observability for the workload 202 is less than the observability priority of the compute observability and the storage observability, based on the metric priority value of the network metric being less than the metric priority value of the compute metric and the metric priority value of the storage metric. The workload orchestrator 110 may eliminate the host 120(d) as being one of the other potential destination location(s).

The workload orchestrator 110 may determine the next placement of the workload 202 based on the host 120(d) being eliminated. The workload orchestrator 110 may determine the next placement of the workload 202 utilizing the remaining hosts 120(b) and 120(c). In some instances, the workload orchestrator 110 may determine the observability priority of the storage observability for the workload 202 is greater than the observability priority of the compute observability, based on the metric priority value of the storage metric meeting or exceeding the metric priority value of the compute metric. The workload orchestrator 110 may determine the host 120(c) as the next placement of the workload 202, based on determining the observability priority of the storage observability for the workload 202 is greater than the observability priority of the compute observability.

At “7,” the host 120(c) may perform functions to execute a workload 202 based on workload placement utilizing requested metric(s) 204, in a similar way as for the host 120(a) that executes the workload 112 based on workload placement utilizing the requested metric(s) 116 at “6,” as discussed above with reference to FIG. 1. At “8,” the monitoring service 114 may perform similar functions utilizing a workload 202 and requested metric(s) 204, in a similar way as for the workload 112 and the requested metric(s) 116 at “7,” as discussed above with reference to FIG. 1. At “9,” the user device 108 may perform similar functions utilizing a workload 202 and requested metric(s) 204, in a similar way as for the workload 112 and the requested metric(s) 116 as at “8,” as discussed above with reference to FIG. 1. The user interface 124 may output monitoring metrics 208, including storage metrics and network metrics associated with the workload 202 being executed by the host 120(c). Because the host 120(c) does not provide compute observability, the user interface 124 does not output compute metrics associated with the workload 202 being executed by the host 120(c).

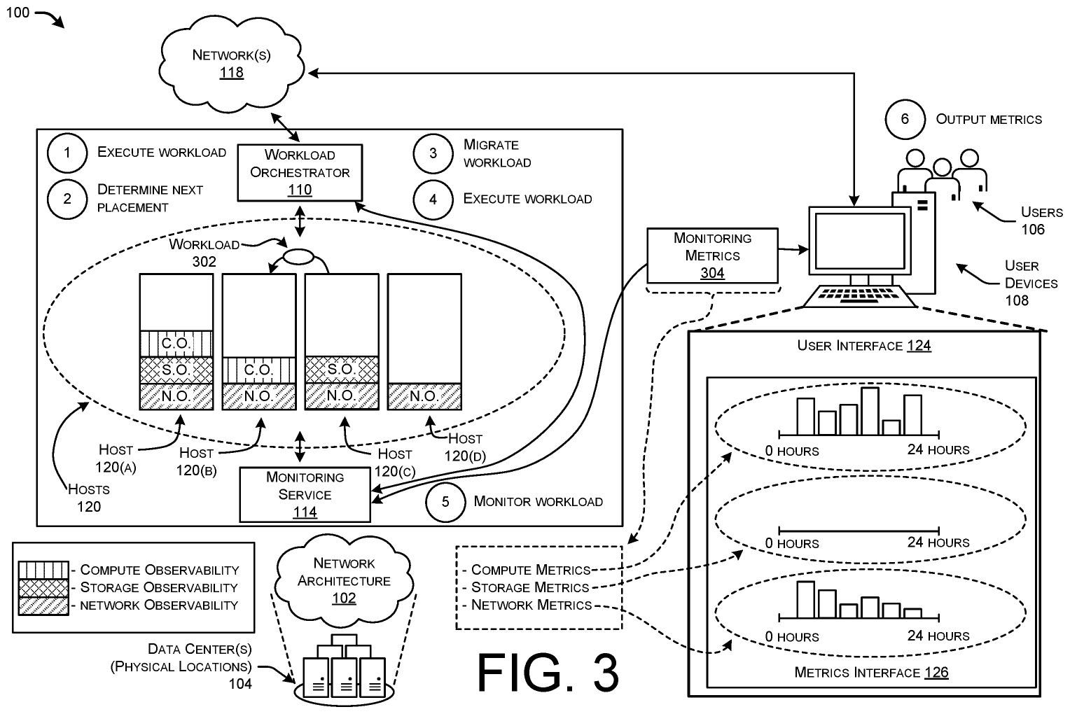

FIG. 3 illustrates a system-architecture diagram of an environment that includes a network architecture that may include one or more data centers, and in which a user of a user device utilizes a monitoring service and a workload orchestrator to execute a workload. FIG. 3 further illustrates a workload orchestrator in a network architecture deploying the workload based on performance of execution of the workload.

As illustrated, at “1,” the host 120(c) may perform functions to execute a workload 302 based on workload placement utilizing one or more requested metrics, in a similar way as for the host 120(a) that executes the workload 112 based on workload placement utilizing the requested metric(s) 116 at “6,” as discussed above with reference to FIG. 1. Prior to executing the workload 302, the workload orchestrator 110 may determine a placement for execution of the workload 302, and place the workload 302 based on a determined destination location, according to any of the techniques as discussed above with reference to FIGS. 1 and 2.

At “2,” the workload orchestrator 110 may determine a next placement associated with the workload 302. The determining of the next placement of the workload 302 may include monitoring execution of the workload 302 to determine monitoring information, determining a migrate status associated with the workload 302 based on the monitoring information, and determining the next placement associated with the workload 302 based on the migrate status.

The workload orchestrator 110 may determine to migrate the workload 302 based on various types of monitoring information. The monitoring information may be determined based on monitoring performed based on execution of the workload 302. The monitoring performed based on the execution of the workload 302 may include monitoring performance of the execution of the workload 302, and/or determining one or more monitoring metrics based on the monitoring of the performance. The initial monitoring metric(s) may be determined based on one or more requested metrics, which may be determined in a similar way as discussed above with reference to FIGS. 1 and 2. Individual ones of the initial monitoring metric(s) may be associated with corresponding metrics of the requested metric(s). The initial monitoring metric(s) may include multiple initial monitoring metrics associated with a host (e.g., the host 120(c)) currently executing the workload 302. Individual ones of the initial monitoring metrics may be associated with corresponding observability provided by the host 120(c). By way of example, the initial monitoring metrics may include one or more initial storage metrics (e.g., first storage metric(s)) associated with storage observability provided by the host 120(c), and one or more initial network metrics (e.g., first network metric(s)) associated with network observability provided by the host 120(c).

The workload orchestrator 110 may determine and/or modify observability priorities associated with metric priority values (or “intuited metric priority values”). Individual ones of the observability priorities may be associated with corresponding intuited metric priority values associated with corresponding metric priorities. In some examples, the workload orchestrator 110 may determine one or more observability priorities in a similar way as for the determining of the observability priority(ies), as discussed above with reference to FIG. 2, except by utilizing one or more intuited metric priority values instead of the requested metric priority value(s). In other examples, for cases in which the workload orchestrator 110 previously determined the observability priority(ies) (or “initial observability priority(ies)”) based on the requested metric priority value(s), the workload orchestrator 110 may modify the initial observability priority(ies) based on the intuited metric priority value(s).

Observability priorities may be determined based on various types of metric priority values. One or more observability priorities (or “modified observability priority(ies)”) may be determined based on the initial observability priority(ies). In some examples, the requested metric priority value(s) may be replaced by the intuited metric priority value(s) to replace the initial observability priority(ies) with the modified observability priority(ies). In other examples, the requested metric priority value(s) may be integrated with the intuited metric priority value(s) to determine combined observability priority(ies) as the modified observability priority(ies). Individual ones of the requested metric priority value(s) may be combined with corresponding intuited metric priority value(s) to determine the combined observability priority(ies). By way of example, individual ones of the combined deployment weight(s) may be a combination (e.g., an average) of the corresponding requested metric priority value(s) and the corresponding intuited metric priority value(s).

The monitoring information may include the intuited metric priority value(s) and/or any information associated with the performance of the execution of the workload 302. In some instances, the monitoring information may be utilized to determine whether to migrate the workload 302. For instance, the workload orchestrator 110 may determine a value of the migrate status associated with the workload 302 as positive, based on determining at least one observability priority associated with a corresponding type of observability that is not provided by the host 120(c) meets or exceeds observability priorities of the types of observability that are provided by the host 120(c). In some examples, the workload orchestrator 110 may determine the migrate status associated with the workload 302 as positive, further based on determining individual ones of the intuited metric priority values associated with corresponding type(s) of observability (e.g., the compute observability) that are not provided by the host 120(c) meet or exceed the intuited metric priority values that are associated with the corresponding types observability (e.g., the storage observability and the network observability) that are provided by the host 120(c).

The workload orchestrator 110 may determine the next placement for the workload 302 based on the migrate status, by refraining from comparing types of observability provided by potential destination locations that are the same as types of observability provided by a current host executing the workload 302. By way of example, the workload orchestrator 110 may refrain from comparing one or more types of observability (e.g., network observability) provided by potential destination locations (e.g., the hosts 120(b) and 120(d)) that are the same as one or more types of observability (e.g., network observability) provided by a current host (e.g., the host 120(c)) executing the workload 302. Because both of the hosts 120(b)-120(d) provide network observability, the workload orchestrator 110 may determine the next placement based on one or more types of observability (e.g., the compute observability) that are not provided by the host 120(c). The workload orchestrator 110 may determine the next placement based on the compute observability being associated with the intuited metric priority value that is greater than the intuited metric priority value associated with the storage observability.

At “3,” the workload orchestrator 110 may migrate the workload 302 based on the migrate status, in a similar way as for placing the workload 302. By way of example, the workload orchestrator 110 may migrate the workload 302 by placing the workload 302 on the host 120(b), based on determining availability of the host 120(b) is positive. The workload orchestrator 110 may place the workload 302 on the host 120(b) based on determining availability of the host 120(b) is positive, in a similar way as for placing the workload 302 on the host 120(a) at “5,” as discussed above with reference to FIG. 1. At “4,” the host 120(b) may execute the workload 302, in a similar way as for the host 120(a) executing the workload 112 at “6,” as discussed above with reference to FIG. 1.

At “5,” the monitoring service 114 may perform similar functions utilizing a workload 202 and requested metric(s) 204, in a similar way as for the workload 112 and the requested metric(s) 116 at “7,” as discussed above with reference to FIG. 1. At “6,” the user device 108 may perform similar functions utilizing a workload 202 and requested metric(s) 204, in a similar way as for the workload 112 and the requested metric(s) 116 as at “8,” as discussed above with reference to FIG. 1. The user interface 124 may output monitoring metrics 304, including compute metrics and network metrics associated with the workload 302 being executed by the host 120(b). Because the host 120(b) does not provide compute observability, the user interface 124 does not output storage metrics associated with the workload 302 being executed by the host 120(b).

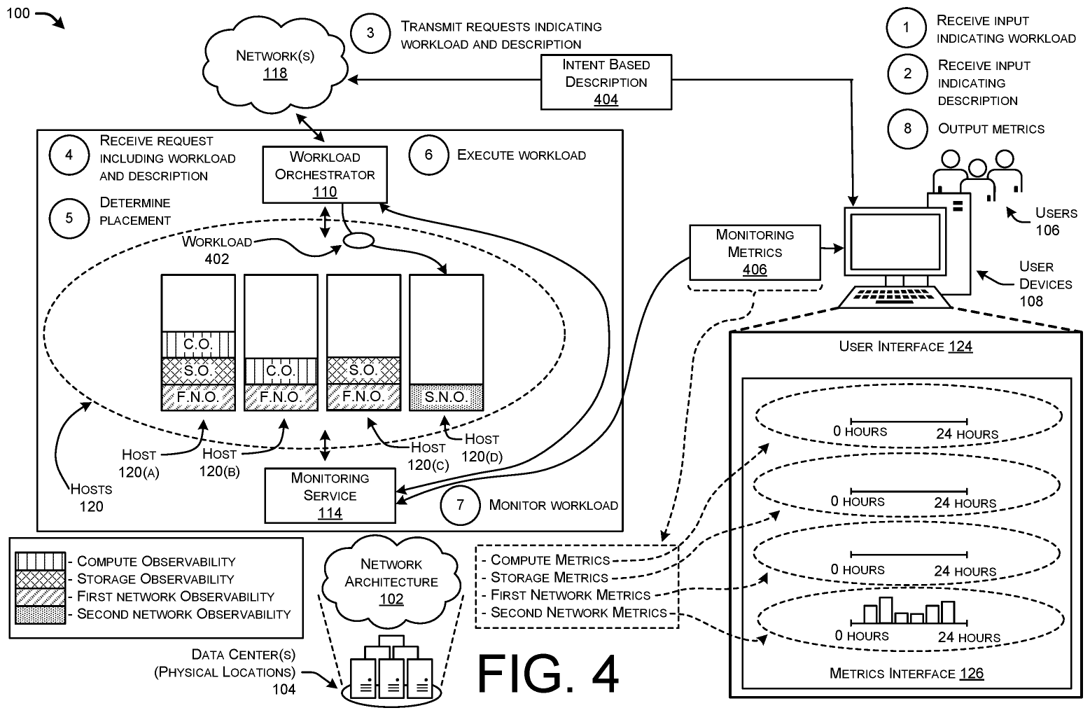

FIG. 4 illustrates a system-architecture diagram of an environment that includes a network architecture that may include one or more data centers, and in which a user of a user device utilizes a monitoring service and a workload orchestrator to execute a workload. FIG. 3 further illustrates a workload orchestrator in a network architecture deploying the workload based on intent based descriptions.

As illustrated, at “1” the user device 108 may perform similar functions utilizing a workload 402, in a similar way as for the workload 112 at “1,” as discussed above with reference to FIG. 1. At “2,” the user device 108 may receive user data from a user account associated with the user 106. The user data (e.g., data associated with the user account) may be associated with one or more selections received via user input to the user device 108. The user data may indicate a description (e.g., intent based description) 404 indicative of one or more computing resources utilized by the workload 402. In some instances, the intent based description 404 may include details associated with one or more types (e.g., computing resource type(s)) of the computing resource(s). For instance, a computing resource, or a type of a computing resource, utilized by the workload 402 may be indicated by the intent based description 404. The user request may include the intent based description (or “intent based information”) to provide workload details including how the workload 402 is executed, one or more goals and/or one or more purposes associated with execution of the workload 402, one or more requirements (e.g., computer resource requirements) and/or one or more recommendations (e.g., computer resource recommendations) for execution of the workload 402, one or more parameters (e.g., a maximum length of time) for execution of the workload 402, one or more identifiers and/or one or more versions of tools utilized by the computing resource(s) for execution of the workload 402, and the like.

At “3,” the user device 108 may transmit a request (or “user request”) indicating the workload 402 and the intent based description 404 to the workload orchestrator 110, via the network(s) 118. The user request may include any information (or “workload information”) associated with the workload 4012 in a similar way as for the workload 112, as discussed above with reference to FIG. 2. The user request may include the intent based description 404.

At “4,” the workload orchestrator 110 may receive the user request indicating the workload 402 and the intent based description 404. The workload orchestrator 110 may receive, in the user request, the workload information.

At “5”, the workload orchestrator 110 may determine a placement associated with the workload 402. To determine the placement, the workload orchestrator 110 may determine one or more metrics (or “intent based metric(s)”) based on the intent based description 404. By way of example, the computing resource(s), of which the intent based description 404 is indicative, may be utilized to determine (e.g., identify) the intent based metric(s), based on determining the intent based metric(s) that satisfy the intent based description 404. The workload orchestrator 110 may determine one or more potential destination locations for execution of the workload 402, based on the intent based metric(s). The potential destination location(s) may be utilized to determine the placement for the workload 402, in a similar way as for the placement for the workload 112 at “5,” as discussed above with reference to FIG. 1. By way of example, the placement for the workload 402 may be determined by utilizing the intent based metric(s) instead of the request metric(s).

Individual ones of the corresponding types (or “categories”) of observability may include one or more types (e.g., sub-types) (or “sub-categories”) observability. In some instances, the network observability may include a sub-type (e.g., first sub-type) of network observability and another sub-type (e.g., second sub-type) of network observability. For instance, the sub-type of network observability (or “first network observability”) may be provided by one or more hosts 120 (e.g., the host 120(a), the host 120(b), and the host 120(c)); and the other sub-type of network observability (or “second network observability”) may be provided by one or more other hosts 120 (e.g., the host 120(d)).

At “6,” the host 120(d) may execute the workload 402 in a similar way as the host 120(a) executing the workload 112 at “6,” as discussed above with reference to FIG. 1. At “7,” the monitoring service 114 may monitor execution of the workload 402 to determine one or more monitoring metrics 406, in a similar way as the monitoring service 114 monitoring execution of the workload 112 to determine the monitoring metric(s) 122 at “7,” as discussed above with reference to FIG. 1.

At “8,” the user interface 124 may be utilized to output the monitoring metric(s) 406 in a similar way as the user interface 124 being utilized to output the monitoring metrics 122 at “8,” as discussed above with reference to FIG. 1. The user device may receive the monitoring metrics 122, including one or more second network metrics. The user interface 124 may output the monitoring metric(s) 406. The monitoring metric(s) 406 output by the user interface 124 may include the second network metric(s) being output to provide the second network observability.

Although types of observability may be provided, along with sub-types of observability, by outputting types of monitoring metrics and/or sub-types types of monitoring metrics as discussed above with reference to FIG. 4 in this disclosure, it is not limited as such. Any techniques as discussed above with reference to FIGS. 1-3 may be implemented in a similar way by utilizing any combinations of types of monitoring metrics and/or any combinations of sub-types of monitoring metrics, in a similar way as for the types of monitoring metrics.

Although various techniques may be utilized as discussed with reference to FIGS. 1-4 in the current disclosure, it is not limited as such. Any of the techniques as discussed with reference to FIGS. 1-4 may be utilized for any of the workloads, in any combination, and in any order. In some examples, one or more of the requested metrics utilized to place the workload 112 as discussed above with reference to FIG. 1, the availability utilized to place the workload 202 as discussed above with reference to FIG. 2, the migrate status utilized to migrate the workload 302 as discussed above with reference to FIG. 3, and the intent based description 404 utilized to place the workload 402 as discussed above with reference to FIG. 4 may be utilized in any order and in any combination to place (e.g., deploy) and/or migrate (e.g., move) any of one or more of the workloads.

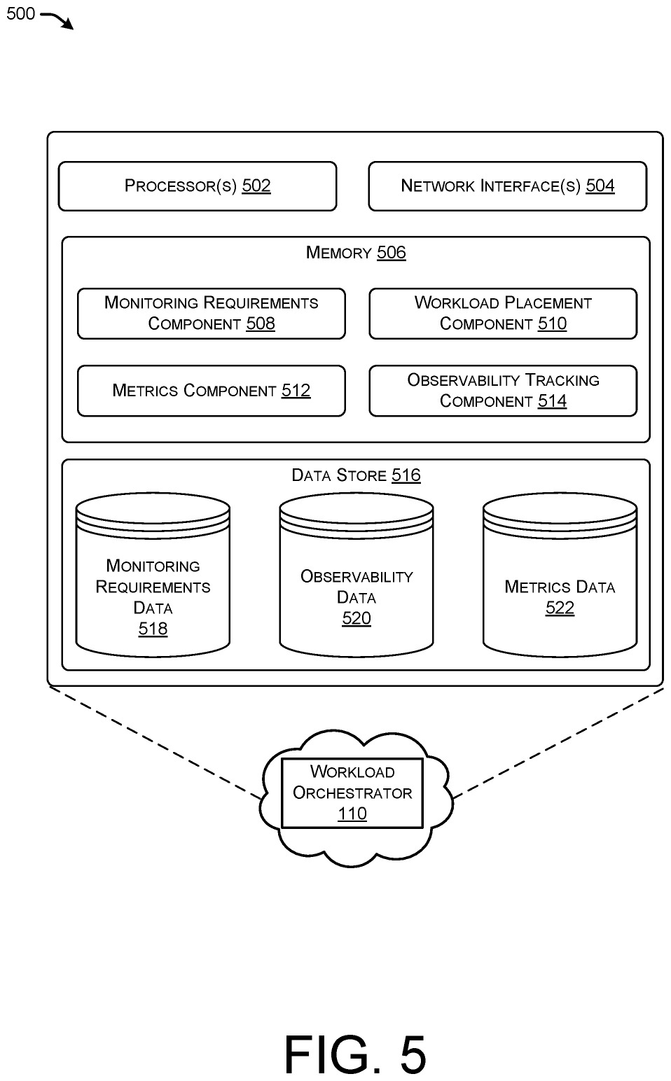

FIG. 5 illustrates a computing system diagram 500 illustrating a configuration for a workload orchestrator that may be utilized to implement aspects of the technologies disclosed herein.

Generally, the workload orchestrator 110 may be a programmable controller that manages some or all of workload placement activities. Generally, the workload orchestrator 110 may handle at least the functions of (i) receiving user requests including metrics, metric priority values, and/or intent based descriptions, (ii) determining metrics based on intent based descriptions, and (iii) utilizing metrics of various types (e.g., requested metrics, orchestrator metrics, and/or intent based metrics), host availability, and/or numbers/priorities of observability types provided by computer resources (e.g., hosts) to determine workload placement.

As illustrated, the workload orchestrator 110 may include, or run on, one or more hardware processors 502 (processors), one or more devices, configured to execute one or more stored instructions. The processor(s) 502 may comprise one or more cores. Further, the workload orchestrator 110 may include or be associated with (e.g., communicatively coupled to) one or more network interfaces 504 configured to provide communications with the user devices 108 and other devices, and/or other systems or devices in the workload orchestrator 110 and/or remote from the workload orchestrator 110. The network interface(s) 504 may include devices configured to couple to personal area networks (PANs), wired and wireless local area networks (LANs), wired and wireless wide area networks (WANs), and so forth. For example, the network interface(s) 504 may include devices compatible with any networking protocol.

The workload orchestrator 110 may also include memory 506, such as computer-readable media, that stores various executable components (e.g., software-based components, firmware-based components, etc.). The memory 506 may generally store components to implement functionality described herein as being performed by the workload orchestrator 110. The memory 506 may store a monitoring requirements component 508 configured to manage monitoring requirements utilized for workload placement. The monitoring requirements component 508 may manage metrics of various types (e.g., requested metrics, orchestrator metrics, intent based metrics, etc.) that are utilized to determine destination locations for placement of workloads and observability types for providing observability based on workload execution.

Further, the memory 506 may store a workload placement component 510 configured to place workloads on computing resources (e.g., hosts). The workload placement component 510 may utilize potential destination locations to determine destination locations and place the workloads on the destination locations. The workload placement component 510 may place the workloads on the destination locations further based on the metrics of various types (e.g., requested metrics, orchestrator metrics, and/or intent based metrics), the host availability, and/or the numbers/priorities of observability types provided by computer resources (e.g., hosts).

Further, the memory 506 may store a metrics component 512 configured to manage metrics (e.g., metrics associated with execution of workloads) that are monitored. The metrics component 512 may receive the monitored metrics from the monitoring service 114 and utilize the monitored metrics as information for determining whether to migrate workloads. The metrics component 512 may manage the monitored metrics based on the monitored metrics being associated with corresponding workloads being executed.

Further, the memory 506 may store an observability tracking component 514 configured to track observability. The observability may be tracked for each of the hosts that are executing workloads. The observability tracking component 514 may determine any observability and/or change of observability associated with the hosts, which may be utilized to determine placement and/or migration of workloads.

The workload orchestrator 110 may further include a data store 516, such as long-term storage, that stores monitoring requirements data 518, such as data including metrics of various types (e.g., requested metrics, orchestrator metrics, intent based metrics, etc.). The data store 518 may store workload observability data 520 that indicates observability provided by hosts, including any changes in observability provided by the hosts. The data store 518 may store metrics data 522 that indicates metrics that are monitored based on execution of the workloads. The metrics data 522 may be utilized to determine whether the workloads are placed correctly or whether to migrate the workloads.

In some instances, the steps of method 600 may be performed by a device and/or a system of devices that includes one or more processors and one or more non-transitory computer-readable media storing computer-executable instructions that, when executed by the one or more processors, cause the one or more processors to perform operations of method 600.

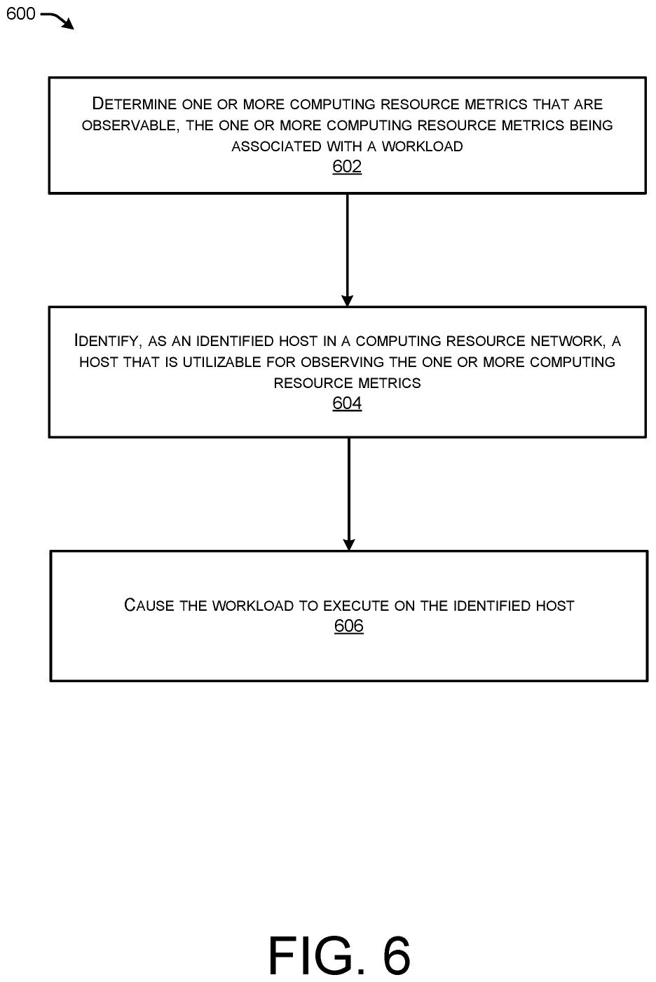

FIG. 6 illustrates a flow diagram of an example method 600 for deploying a workload.

At 602, a workload orchestrator 110 may determine one or more computing resource metrics that are observable. The computing resource metric(s) may be associated with a workload. The computing resource metric(s) may include one or more compute metrics, one or more storage metrics, and/or one or more network metrics. The computing resource metric(s) may include requested metric(s) indicated by a user request received from a user device.

At 604, the workload orchestrator 110 may identify, as an identified host in a computing resource network, a host that is utilizable for observing the one or more computing resource metric. The host may be determined as the identified host and utilized to execute the workload, based on determining one or more types of observability associated with the host. The type(s) of observability may include multiple types of observability. The requested metric(s) may include multiple requested metrics. The workload orchestrator 110 may determine the number of the types of observability may match the number of the requested metrics. The workload orchestrator 110 may determine each of the types of observability matches a corresponding type of observability associated with a corresponding metric among the requested metrics. By way of examples, the workload orchestrator 110 may determine the types of observability include i) compute observability matching compute observability associated with a compute metric among the requested metrics, ii) storage observability matching storage observability associated with a storage metric among the requested metrics, and iii) network observability matching network observability associated with a network metric among the requested metrics.

At 606, the workload orchestrator 110 may cause the workload to execute on the identified host. The workload may be executed on the identified host, based on the workload orchestrator 110 determining availability of the identified host is positive.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A monitoring service network architecture, comprising:
one or more processors; and
one or more non-transitory computer-readable media storing computer-executable instructions that, when executed by the one or more processors, cause the one or more processors to perform operations comprising:
determining one or more computing resource metrics that are observable, the one or more computing resource metrics being associated with a workload;
identifying, as an identified host in a computing resource network, a host that is utilizable for observing the one or more computing resource metrics; and
causing the workload to execute on the identified host.

2. The monitoring service network architecture of claim 1, wherein the one or more computing resource metrics comprise multiple computing resource metrics.

3. The monitoring service network architecture of claim 1, the operations further comprising:
determining that no host among multiple hosts is available for providing observability for all of the one or more computing resource metrics, wherein identifying the host further comprises determining the host is available for providing at least one of the one or more computing resource metrics.

4. The monitoring service network architecture of claim 1, the operations further comprising:
receiving historical data indicating resource consumption by the workload, the resource consumption being associated with a resource of a computing resource type among multiple computing resource types.

5. The monitoring service network architecture of claim 1, the operations further comprising:
determining, based at least in part on historical data associated with workload resource consumption, a priority value of a computing resource metric among the one or more computing resource metrics; and
determining to observe the computing resource metric, based at least in part on the priority value of the computing resource metric meeting or exceeding a threshold priority value.

6. The monitoring service network architecture of claim 1, the operations further comprising:
receiving input data from a user account associated with the workload, the input data indicating utilization of a computing resource; and
determining to monitor a computing resource metric associated with the computing resource.

7. The monitoring service network architecture of claim 1, the operations further comprising:
receiving input data from a user account, the input data indicating an intent based description indicative of a computing resource utilized by a second workload;
identifying, based at least in part on the intent based description, a resource consumption characteristic associated with the second workload;
identifying a second host, based at least in part on the resource consumption characteristic; and
determining to collect a computing resource metric associated with execution of the second workload by the second host.

8. A method, for a monitoring service network architecture, the method comprising:
determining one or more computing resource metrics that are observable, the one or more computing resource metrics being associated with a workload;
identifying, as an identified host in a computing resource network, a host that is utilizable for observing the one or more computing resource metrics; and
causing the workload to execute on the identified host.

9. The method of claim 8, wherein the one or more computing resource metrics comprise multiple computing resource metrics.

10. The method of claim 9, further comprising:
determining that no host among multiple hosts is available for providing observability for all of the one or more computing resource metrics, wherein identifying the host further comprises determining the host is available for providing at least one of the one or more computing resource metrics.

11. The method of claim 8, further comprising:
receiving historical data indicating resource consumption by the workload, the resource consumption being associated with a resource of a computing resource type among multiple computing resource types.

12. The method of claim 8, further comprising:
determining, based at least in part on historical data associated with workload resource consumption, a priority value of a computing resource metric among the one or more computing resource metrics; and
determining to observe the computing resource metric, based at least in part on the priority value of the computing resource metric meeting or exceeding a threshold priority value.

13. The method of claim 8, further comprising:
receiving input data from a user account associated with the workload, the input data indicating utilization of a computing resource; and
determining to monitor a computing resource metric associated with the computing resource.

14. The method of claim 8, further comprising:
receiving input data from a user account, the input data indicating an intent based description indicative of a computing resource utilized by a second workload;
identifying, based at least in part on the intent based description, a resource consumption characteristic associated with the second workload;
identifying a second host, based at least in part on the resource consumption characteristic; and
determining to collect a computing resource metric associated with execution of the second workload by the second host.

15. A computing device, comprising:
one or more processors; and
one or more non-transitory computer-readable media storing computer-executable instructions that, when executed by the one or more processors, cause the one or more processors to perform operations comprising:
determining one or more computing resource metrics that are observable, the one or more computing resource metrics being associated with a workload;
identifying, as an identified host in a computing resource network, a host that is utilizable for observing the one or more computing resource metrics; and
causing the workload to execute on the identified host.

16. The computing device of claim 15, wherein the one or more computing resource metrics comprise multiple computing resource metrics.

17. The computing device of claim 15, the operations further comprising:
determining that no host among multiple hosts is available for providing observability for all of the one or more computing resource metrics, wherein identifying the host further comprises determining the host is available for providing at least one of the one or more computing resource metrics.

18. The computing device of claim 15, the operations further comprising:
receiving historical data indicating resource consumption by the workload, the resource consumption being associated with a resource of a computing resource type among multiple computing resource types.

19. The computing device of claim 15, the operations further comprising:
determining, based at least in part on historical data associated with workload resource consumption, a priority value of a computing resource metric among the one or more computing resource metrics; and
determining to observe the computing resource metric, based at least in part on the priority value of the computing resource metric meeting or exceeding a threshold priority value.

20. The computing device of claim 15, the operations further comprising:
receiving input data from a user account associated with the workload, the input data indicating utilization of a computing resource; and
determining to monitor a computing resource metric associated with the computing resource.
